(19) United States
(12) Patent Application Publication
(10) Pub. No.: US 2006/0026153 A1
(43) Pub. Date: Feb. 2, 2006

(54) Hypercube topology based advanced search algorithm

(76) Inventor: Srikanth P. Soogoor, Richardson, TX (US)

Correspondence Address: MICHAEL L. DIAZ, P.C., 555 REPUBLIC DRIVE, SUITE 200, PIANO, TX, 75074, US

(21) Appl. No.: 10/899,694

(22) Filed: Jul. 27, 2004

(51) Int. Cl. G06F 17/30; G06F 7/00

(52) U.S. Cl. 707/5

(57) ABSTRACT

The present invention is a system and method of conducting an adaptive search from a plurality of data sources utilizing a hypercube topology. The system includes a search engine which utilizes a hypercube architecture having a plurality of hypercubes. Each hypercube indexes several data sources in a manner such that similar data sources are located in proximity with other similar data sources. In addition, the search engine utilizes a plurality of message passing ants providing a signal of a path taken for other message passing ants to follow.

### BACKGROUND OF THE INVENTION

1. Field of the Invention

This invention relates to searching services. Specifically, the present invention relates to an advanced search algorithm for use in a networked environment.

2. Description of the Related Art

Tremendous advances have been made in providing web services to both consumers and business enterprises. With the increased use of the Internet to transfer information between companies and consumers, the task of organizing and utilizing this information is daunting. Today, business enterprises utilize a real-time business intelligence for processing this information. Existing business intelligence may be considered a “data refinery.” In a similar manner as oil refineries are used to convert a raw material (oil) into several products (e.g., gasoline, jet fuel, kerosene, and lubricants), real-time business intelligences take another raw material (data) and process it into several products for consumers and enterprises in real-time.

Although the existing business intelligence systems manage some forms of data very well, the management of both structured and unstructured data is beyond their capabilities. A business intelligence, and more specifically, an adaptive searching algorithm is needed which can process both structured and unstructured data in an efficient and meaningful manner is needed.

Thus, it would be a distinct advantage to have a searching algorithm which can efficiently and accurately process both structured and unstructured data. The algorithm should be adaptive and used in conjunction with business intelligences of various business enterprises.

### SUMMARY OF THE INVENTION

In one aspect, the present invention is an adaptive searching system. The system includes a search engine for receiving and processing search queries. The search engine utilizes an adaptive search algorithm. The system also includes at least one interface device for communicating with the search engine. The interface device provides a communication link between a user providing a search query to the search engine. In addition, the system includes a plurality of indexed data sources. The search engine utilizes a plurality of message passing ants. Each message passing ant searches the indexed plurality of data sources to answer the search query. The message passing ants also deposit a signal of a path traversed. Other message passing ants may then follow the path by following the signals deposited by other message passing ants.

In another aspect, the present invention is an adaptive searching algorithm responding to a search query from a user through an interface device. The algorithm includes a search engine for receiving and processing search queries. In addition, a plurality of data sources is indexed. In addition, the algorithm uses a plurality of message passing ants. Each message passing ant provides a signal of a path followed in searching the plurality of data sources in response to the search query. Other message passing ants may then follow the signal deposited by a message passing ant while searching the plurality of data sources.

In still another aspect, the present invention is a method of adaptively searching a plurality of data sources within a network. The method begins by indexing the plurality of data sources. Next, a search query is sent by a user to a search engine. Message passing ants are then sent to the data sources searching an answer to the search query. Each message passing ant deposits a signal to indicate a path traversed by the message passing ant during its search. Other message passing ants may then follow the path taken by previous message passing ants. A response to the search query is sent by at least one message passing ant searching the plurality of data sources to the search engine.

In another aspect, the present invention is a searching algorithm providing an indexed hypercube topology. The searching algorithm includes a plurality of data sources. The algorithm also includes a plurality of cubes. Each cube has a plurality of nodes associated with the data sources. The data sources are indexed and positioned in proximity to another data source based on a similarity of information of the data sources.

### BRIEF DESCRIPTION OF THE DRAWINGS

FIG. 1 is a simplified block diagram of a web service system in the preferred embodiment of the present invention;

FIG. 2 illustrates a topology of a hypercube used for indexing data on the various nodes of the system in the preferred embodiment of the present invention;

FIG. 3 depicts a 4-layered 4-cube hypercube topology in the preferred embodiment of the present invention;

FIGS. 4A and 4B are flow charts outlining the steps for conducting a search within the system according to the teachings of the present invention;

FIG. 5 is a flow chart outlining the steps for conducting the adaptive search algorithm according to the teachings of the present invention.

### DESCRIPTION OF THE INVENTION

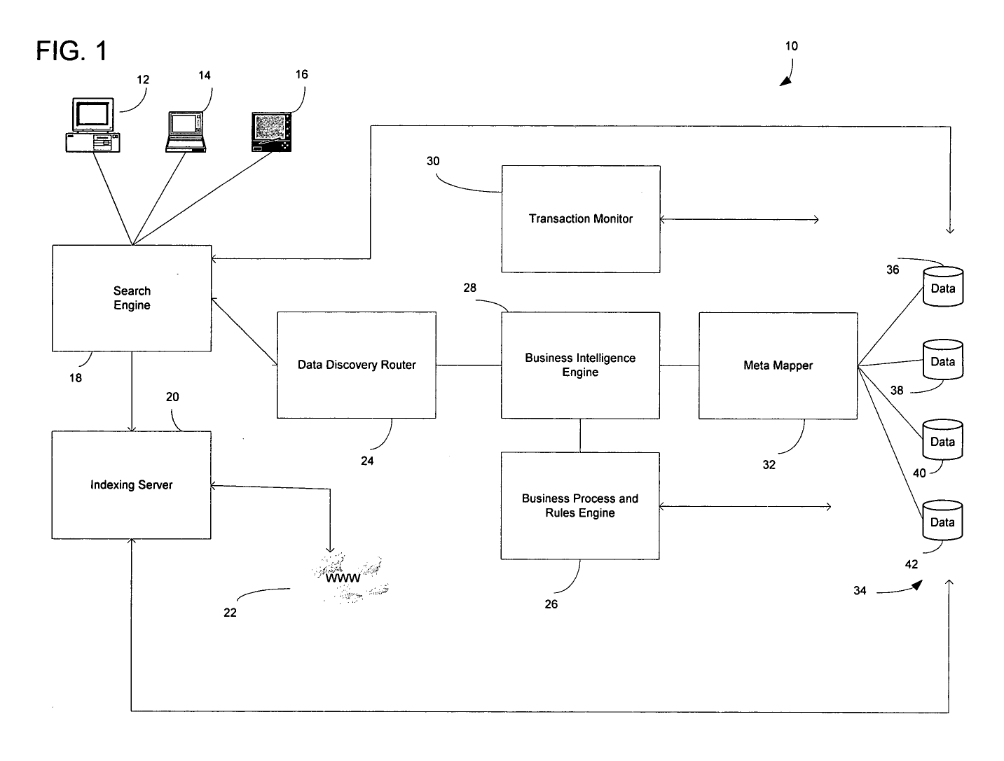

An adaptive search algorithm system and method are disclosed. FIG. 1 is a simplified block diagram of a web service system 10 in the preferred embodiment of the present invention. The system includes a plurality of interface devices 12, 14, and 16. The interface devices may be any computing or communication device communicating in the system 10. The interface devices may be mobile phones, personal data assistants (pda's), laptops, computers, etc. The interface devices are operated by consumers or users of the system 10. Within the system 10 is a search engine 18 and an indexing server 20. The system 10 incorporates the World Wide Web (Internet) 22 with the other components of the system. In addition, the system includes a data discovery router 24, a business process and rules engine 26, a business intelligence engine 28, a transaction monitor 30 and a meta mapper 32. A corporate database group 34 comprises a plurality of corporate databases 36, 38, 40, and 42. The various components of the system 10 may reside in one or more computing systems, such as servers or other computer workstations. Additionally, some or all of the components may include a computer processor and memory as needed to perform the functions within the system 10. Preferably, the business intelligence engine, business process and rules engine, the transaction monitor and the meta mapper all are associated with a specific business enterprise running one or more corporate databases. The corporate databases preferably reside at a site separate from the search engine, indexing server and data discovery router. Alternatively, the corporate databases may reside with one or more of the other components of the system 10. The transaction monitor provides a monitoring function between any message sent or received from the corporate nodes (databases). The meta mapper provides a virtual database of all the corporate databases associated with a specific business enterprise.

The search engine is the gateway for all searching requests from the users of the interface devices 12, 14, and 16 to the system 10. In the preferred embodiment of the present invention, the interface devices are embedded within their computing systems with a search engine footprint. When a user logs in with the system 10 for the first time, a web service request is activated and ready to make a request. Preferably, the search engine footprint is a program occupying a small amount of memory within each interface device's computing system. The search engine footprint may include memory holding user preferences to assist in the searching requests of the user.

When a search request is made by a user through the interface device, a web service request is sent to the data discovery router 24 via the search engine 18. The data discover router 24 determines where the web service request needs to be routed, such as the Internet 22, the corporate databases 36, 28, 40, 42, or other sources. Once the data discovery router determines where to send the web service request, a number of background queries are generated and sent. The primary query for the web service request is the source that most closely matches the data discovery router's determination.

In the event that the data discovery router's recommendation is to a corporate database, then the business intelligence engine 28 is activated. The business intelligence engine processes the requests based on the business process and rules engine 26's configuration and rules setup. For example, the business process and rules engine may provide rules for a plurality of consumers. A consumer may be provided with a special discount if the consumer spent a specified amount of money in the previous year. The business intelligence engine is a platform that takes the output of the business process and rules engine and presents the necessary solution for use in the search engine and processing the search requests.

The search engine 18 is adaptive and utilizes a novel concept known as an ant colony optimization algorithm in a hypercube topology based environment. The search engine optionally adapts itself to the user's profile. However, a profile setup is not mandatory for a user to use the system. In the preferred embodiment of the present invention, the user's preferences are provided in initial setup through the search engine footprint of the user's interface device.

The search engine is preferably located with a computer server well known in the art. However, the search engine may be located in any computing system allowing communication through the system 10. The search engine includes a capability to perform a generic search, a personal search, a corporate database search and receipt of sponsored advertisements.

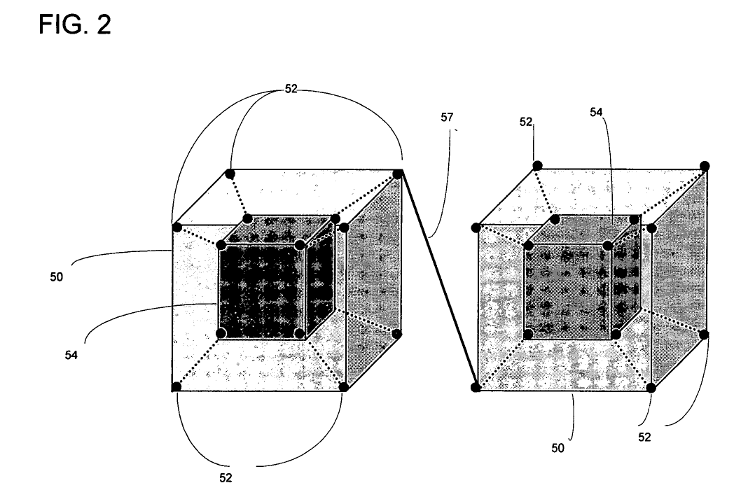

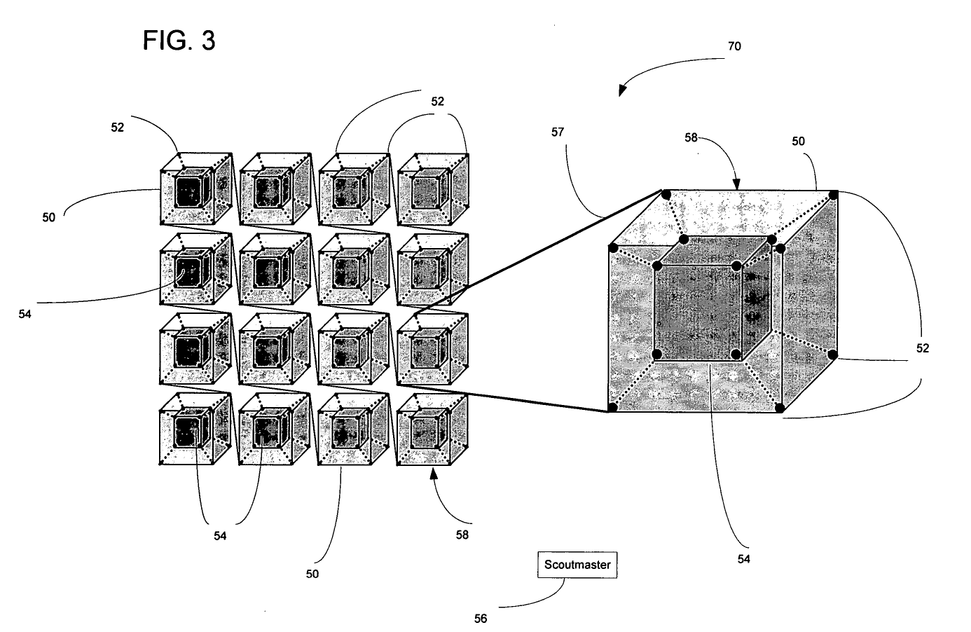

In order to facilitate the enhanced searching capabilities of the search engine 18, a novel architecture is utilized. The search engine uses web crawler bots to traverse the web to create an index of all the websites. This indexing is performed prior to any search request. These websites under meta data are grouped in a n-layered hypercube topology with the longest distance between any two points being no more than log(n) base 2 nodes. FIG. 2 illustrates a topology of a cube 50 surrounding a cube 54 used for indexing data on the various nodes of the system (e.g., servers) according to the teachings of the present invention. As the web crawlers traverse the Internet, more daisy chained hypercubes topology may be built (see FIG. 3). Vertices 52 (“point or node”) of the hypercube 50 represent an indexed search data point. The data points or data sources may be web pages, meta data or a combination of both. Lines depicted between the data points show pathways. One node from one cube is connected by a pathway 57 in an adjacent cube. The indexing server 20 preferably operates using the Linux operating system and use Intel processors. However, any processor and operating system may be used. The indexing server provides an index of all the data sources found by the web crawler bots.

A hypercube is a cube with more than three dimensions. A single (2ˆ0=1) point (or “node”) may be considered as a zero dimensional cube, two (2ˆ1) nodes joined by a line (or “edge”) form a one-dimensional cube, four (2ˆ2) nodes arranged in a square form a two dimensional cube and eight (2ˆ3) nodes form an ordinary three dimensional cube. Following this geometric progression, the first hypercube has 2ˆ4=16 nodes and is a four dimensional shape (a “four-cube”). An N dimensional cube has 2ˆN nodes (an “N-cube”). To make an N+1 dimensional cube, two N dimensional cubes are joined at each node on one cube to the corresponding node on the other cube. A four-cube may be visualized as a three-cube with a smaller three-cube centered inside it with edges radiating diagonally out (in the fourth dimension) from each node on the inner cube to the corresponding node on the outer cube.

Each node in an N dimensional cube is directly connected to N other nodes (e.g., pathway 57). Each node may be identified by a set of N Cartesian coordinates where each coordinate is either zero or one. Two nodes are directly connected if they differ in only one coordinate.

The simple, regular geometrical structure and the close relationship between the coordinate system and binary numbers make the hypercube an appropriate topology for a parallel computer interconnection network. The fact that the number of directly connected, “nearest neighbor”, nodes increases with the total size of the network is also highly desirable for a parallel computation. The proximity of the data points is defined during the mapping process by specifying, through the indexing server 20, indexing definitions. The definitions define the proximity of the information found.

FIG. 3 depicts a 4-layered 4-cube hypercube topology in the preferred embodiment of the present invention. FIG. 3 illustrates a hypercube architecture 70 having a plurality of cubes 50 and 52. The hypercube architecture is fully distributed and utilizes Message Passing Interface (MPI). MPI is implemented by use of “ant colony optimizations.” Ant colony optimization is an evolution-based search technique for the solution of difficult combinatorial problems. The ant colony optimization follows the analogy of ants, which leave a pheromone trail. It should be understood that the layers of cubes as well as the number of cubes may vary depending on the search and amount of data sources available.

These ants, unlike the web crawlers, possess the MPI and are known as Mespa's (message passing ants). The Mespas use memory to store partial solutions. The Mespas live in a discrete world, which provides for independent operation of each Mespa with an awareness of other Mespas. The Mespas have heuristic information and may perform a local search. Additional, the Mespas have a limited intelligence allowing a look ahead capability. The Mespas follow the trails as depicted on the hypercube topology (lines between vertices 52). The Mespas deposit an analogous pheromone which is problem dependent and a function of the solution quality. The analogous pheromone is a signal deposited by each Mespa providing a trail for other Mespas to follow. As more Mespas traverse the trail, the pheromones (signals) deposited become stronger. Therefore, once a plurality of Mespas traverse a path, other Mespas will follow. This follows the analogy of a colony of ants which, at first sends a few ants to scout ahead for food. Once several ants follow a specific path to a food source, other ants follow the pheromones on the trail and are led to the food source.

The algorithm for searching within the plurality of hypercubes includes several assumptions. The algorithm assumes that there is a web crawler (Mespa) that is both scalable and incremental. The hypercubes keep a local copy of the web pages with the meta data in a repository which is eventually used for indexing, mining and personalization. Each node of the hypercube topology includes a set of information on a particular web page. These nodes of the web pages have been built using the concept of proximity cluster. The distance from one node to the next node or any other node signifies the “proximity” or “closeness” of those two web pages.

Each hypercube (or plurality of cubes) is assigned at least one web crawler (Mespa). Also a scoutmaster is utilized to determine which Mespa goes to which hypercube and start a search. The scoutmaster is ultimately responsible for the search result. A scoutmaster 56 is depicted on FIG. 3. The position and the number of scoutmasters is exemplary only and may be varied. In addition, a plurality of Mespas 58 are also depicted on FIG. 3. The Mespas traverse the paths between each node and search the various data points.

For each Mespa K, the probably of p(k, t, w) of moving from node t to node w depends on the combination of two values: the attractiveness n(t,w) on the hypercube of the move, as computed by some heuristic indicating the a priori desirability of the move and the trail level tl (t, w) on the hypercube of the move, indicating how proficient it has been in the past to make that particular move. This represents a posteriori indication of the desirability.

Trails are preferably updated when the Mespas have completed their search, increasing or decreasing the level of trails corresponding to moves that were part of “good” or “bad” search, respectively.

The algorithm includes a tabu list [L] of all the Mespas (inactive list). A randomly selected Mespa is sent to the hypercube 50 for the next search request from the tabu list. Additionally, a scoutmaster is initialized. The scoutmaster selects a hypercube for the search. The scoutmaster initializes p(k, t, w) and n(t,w). Next, the Mespas on a specific hypercube (e.g., hypercube h), perform a parallel operation. Each Mespa is responsible for a cube c. Next, the probability is determined to move into the cube c. The requested search items are searched amongst the indexed web pages. If any Mespa finds a requested item, the Mespa returns an answer to the scoutmaster. If the requested item is not found, a message is sent to the scoutmaster that the search results were negative. The scoutmaster then terminates the Mespa that failed the search. The scoutmaster is informed of this termination. The search continues within other hypercubes.

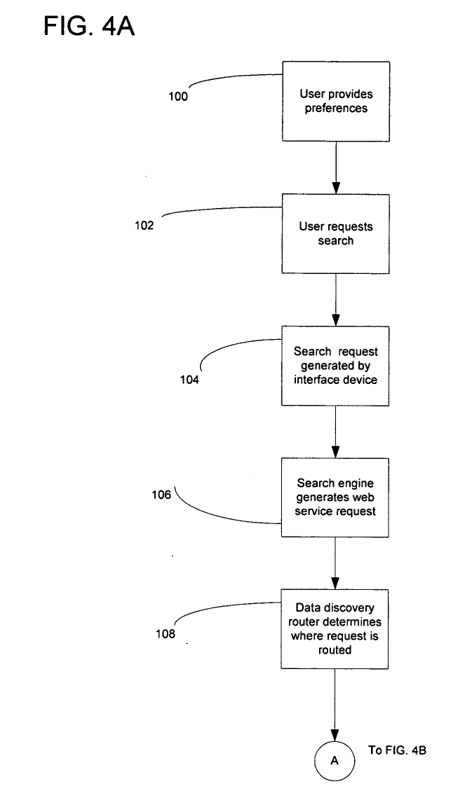

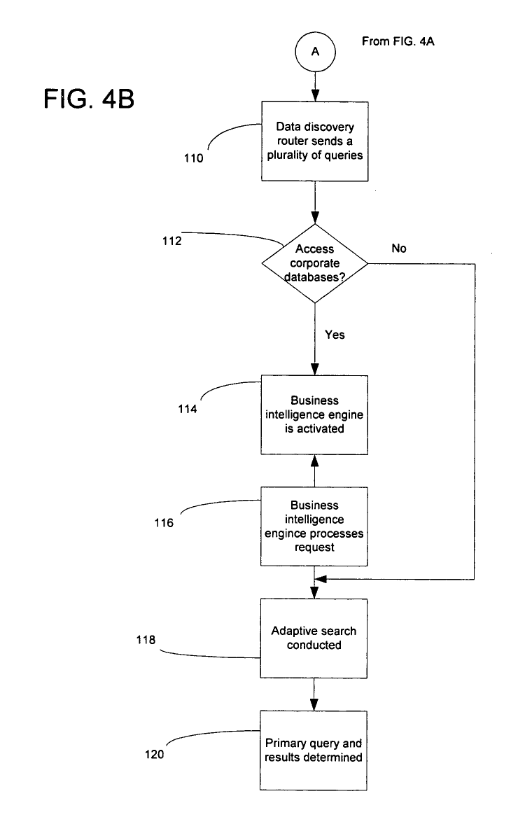

FIGS. 4A and 4B are flow charts outlining the steps for conducting a search within the system 10 according to the teachings of the present invention. With reference to FIGS. 1-3, 4A, and 4B, the steps of the method will now be explained. The method begins with step 100 where the user optionally provides preferences through the search engine footprint embedded within the interface device. The preferences may include any information, which may be helpful in performing a search, such as a user's home address, interests, buying habits, etc. Next, in step 102, the user requests a search through the interface device. The method then moves to step 104 where a request is generated from the user's interface device to the search engine 18. In step 106, the search engine generates a web service request and sends the request to the data discovery router 24. In step 108, the data discovery router determines where the request is to be routed. The data discovery router then generates and sends a plurality of queries through the system 10 in step 110.

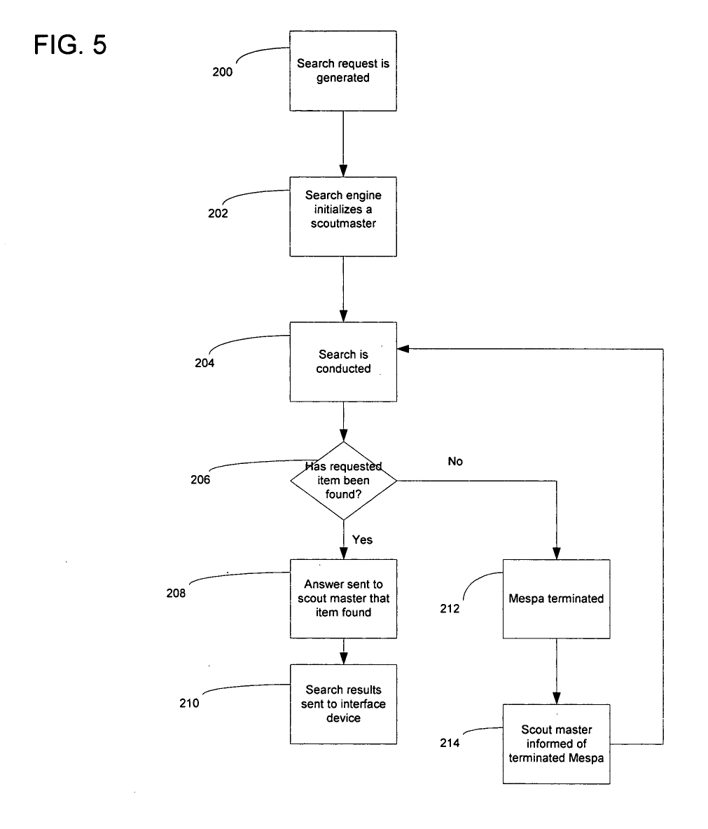

The method then moves to step 112 where it is determined if the data discovery router recommends accessing the corporate database group 34. If it is determined that the corporate database group should be accessed, the method moves to step 114 where the business intelligence engine 28 is activated. Next, in step 116, the business intelligence engine processes the request based on the business process and rules engine 26 configuration and rules set. The business process and rules engine's configuration is setup as desired to provide specified rules and policies incorporated in the use of the corporate data group 34. The method then moves to step 118 where a search is conducted by the adaptive searching algorithm (explained below in FIG. 5).

However, if it is determined that the data discovery router does not recommend accessing the corporate database group 34, the method moves from step 112 to step 118 where the search is conducted by the adaptive searching algorithm. Next, in step 120, the primary query and results determined by the search engine is sent to the requesting user's interface device.

FIG. 5 is a flow chart outlining the steps for conducting the adaptive algorithm according to the teachings of the present invention. With reference to FIGS. 1-3, and 5, the steps of the method will now be explained. Prior to beginning the search, the various data sources (web pages, meta data, combination of web pages and meta data, etc.) are indexed through the indexing server. The indexing server includes an indexing definitions table which defines information and defines the proximity of data to one another. Therefore, the hypercube topology is in place and fully indexed prior to any search. The method then begins with step 200 where a user generates a search request through the user's interface device. Next, in step 202, the search engine initializes a scoutmaster. During initialization, the scoutmaster selects a hypercube (or plurality of cubes) for conducting the search. In addition, the probability of moving from a node t to a node w [p(k,t,w)] and the attractiveness of the move [n(t,w)] is initialized. Next, in step 204, the search is conducted. Specifically, all Mespas within the hypercube h (selected hypercube or hypercubes) act in parallel. Each Mespa is responsible for a cube c (50 or 54). The probability of the state to move into c is determined. Additionally, each Mespa conducts the search for the requested item.

Next, in step 206, it is determined if the requested item has been found. If it is determined that the requested item has been found, the method moves to step 208 where an answer is returned to the scoutmaster that the requested item has been found. The method then moves to step 210 where the search results are sent to the user through the user's interface device.

However, if it is determined that the item has not been found by the Mespa, the method moves from step 206 to step 212 where the Mespa is terminated. Next, in step 214, the scoutmaster is informed that the Mespa has been terminated. Next, the method moves to step 204 where the search is continued. Initially, Mespas follow a random route in search of answers to the search query. As more Mespas traverse specific trails in the hypercube topology, additional Mespas will follow the trail (attracted to the analogous pheromones). Thus, a trail and error iterative process is conduct whereby as more Mespas travel a specific path, more Mespas follow. The search is then focused to those paths having the most traffic.

Although the various components of the system 10 are depicted as separate items, such as the search engine 18 and the indexing server 20, the present invention may include components in one or more locations. Additionally, it should be understood that the hypercube architecture is one structure utilized to perform a search using the novel ant colony optimization searching techniques. Any architecture may be implemented to perform the ant colony optimization searching techniques.

The present invention provides many advantages over existing search systems. The present invention enables an adaptive search to be conducted which may process both structured and unstructured data. In addition, the user's preferences may be incorporated into the search request automatically. For example, if a user desires the location of a specific type of restaurant, the search may automatically be conducted of restaurants within a certain radius of the user's home address. In addition, the corporate databases may be utilized by providing specific items of interest to the user, such as sales on particular items (e.g., children's clothes). In addition, the searching algorithm enables a search to be conducted which learns from past searches by incorporating the “ant colony optimization” techniques discussed above.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. An adaptive searching system, said system comprising:
a search engine for receiving and processing search queries, the search engine utilizing an adaptive search algorithm;
an interface device for communicating with the search engine, the interface device providing a communication link between a user providing a search query to the search engine; and
a plurality of data sources;
the search algorithm having an index of the plurality of data sources;
whereby the search engine utilizes a plurality of message passing ants, each message passing ant searching the indexed plurality of data sources to answer the search query and depositing a signal of a path traversed, thereby allowing other message passing ants to follow the path taken by a previous message passing ant.

2. The adaptive searching system of claim 1 wherein the search algorithm indexes the plurality of data sources by forming the data sources into a hypercube topology, the hypercube topology including a plurality of cubes associated with one or more data source, whereby data sources are arranged in proximity to other data sources based upon a similarity of the information possessed by each data source.

3. The adaptive searching system of claim 2 wherein each message passing ant provides a results message to the search engine.

4. The adaptive searching system of claim 3 wherein a search by a message passing ant of a cube is terminated when a search result is negative.

5. The adaptive searching system of claim 1 further comprising:
a plurality of corporate databases, each corporate database storing data related to a specific business enterprise;
a business intelligence engine having a process and rules protocol to determine at least one corporate database providing information associated with the search query.

6. The adaptive searching system of claim 1 further comprising a data discovery router for determining the data sources to respond to the search query from the user.

7. An adaptive searching algorithm responding to a search query from a user through an interface device, the algorithm comprising:
a search engine for receiving and processing search queries;
means for indexing a plurality of data sources;
a plurality of message passing ants, each message passing ant providing a signal of a path followed in searching the plurality of data sources in response to the search query;
whereby other message passing ants follow the signal deposited by a previous message passing ant while searching the plurality of data sources.

8. The adaptive searching algorithm of claim 7 wherein:
the means for indexing a plurality of data sources includes utilizing a hypercube architecture having a plurality of hypercubes, each hypercube having a plurality of nodes associated with the data sources; and
the data sources being indexed in a manner where data sources are positioned in proximity to each other based on similarity of information of the data sources.

9. The adaptive searching algorithm of claim 8 wherein:
a scoutmaster directs the plurality of message passing ants;
whereby the message passing ants follow paths having a deposited signal in response to the search query.

10. A method of adaptively searching a plurality of data sources within a network, the method comprising the steps of:
indexing the plurality of data sources;
sending a search query to a search engine by a user;
sending a plurality of message passing ants to the data sources searching an answer to the search query;
depositing a signal by a first message passing ant to indicate a path traversed by the message passing ant during the search;
determining by a second message passing ant the path taken by the first message passing ant in search of an answer to the search query;
following, by the second message passing ant, the path of the first message passing ant to answer the search query; and
providing a response to the search query by at least one message passing ant searching the plurality of data sources.

11. The method of adaptively searching a plurality of data sources of claim 10 wherein the step of indexing the plurality of data sources includes arranging the data sources into a hypercube topology wherein each data source is positioned in proximity to another data source based on the similarity of information possessed by each data source.

12. A searching algorithm providing an indexed hypercube topology, the searching algorithm comprising:
a plurality of data sources;
a plurality of cubes, each cube having a plurality of nodes;
each data source being indexed with a node of a cube;
whereby each data source is positioned in proximity to another data source based on a similarity of information of the data sources.

13. The searching algorithm of claim 12 wherein the plurality of cubes are grouped into a hypercube.

14. The searching algorithm of claim 13 further comprising a search engine for receiving and processing search queries, the search engine utilizing the search algorithm.

15. The searching algorithm of claim 14 further comprising:
a plurality of message passing ants, each message passing ant providing a signal of a path followed in searching the plurality of data sources in response to a search query;
whereby other message passing ants follow the signal provided by a previous message passing ant while searching the plurality of data sources.

16. The searching algorithm of claim 15 wherein the message passing ants continue a heuristic process of searching the data sources, whereby message passing ants follow paths utilized by previous message passing ants.

17. The searching algorithm of claim 16 further comprising a scoutmaster directing the plurality of message passing ants within the search of the hypercube topology.

18. The searching algorithm of claim 17 wherein each message passing ant provides a results message defining the success of the search.

19. The searching algorithm of claim 12 further comprising:
a corporate database associated with a business enterprise; and
a business intelligence controlling search queries associated with the corporate database.

20. The searching algorithm of claim 19 wherein the business intelligence responds to the search query based upon the origin of the search request.
